(19) United States
(12) Patent Application Publication
(10) Pub. No.: US 2024/0169831 A1
(43) Pub. Date: May 23, 2024

(54) METHOD AND DEVICE FOR PROVIDING TRAFFIC INFORMATION

(71) Applicant: Continental Automotive Technologies GmbH, Hannover (DE)

(72) Inventor: Stefan Hegemann, Wangen im Allgäu (DE)

(73) Assignee: Continental Automotive Technologies GmbH, Hannover (DE)

(21) Appl. No.: 18/515,391

(22) Filed: Nov. 21, 2023

(30) Foreign Application Priority Data
Nov. 21, 2022 (DE) 10 2022 212 414.6

(51) Int. Cl. G08G 1/09

(52) U.S. Cl. CPC G08G 1/091

(57) ABSTRACT

A method for providing traffic information at an intersection, wherein trajectories of a plurality of vehicles are detected over time intervals, paths are identified on the basis of the trajectories and these paths and/or information derived from them are provided as traffic information.

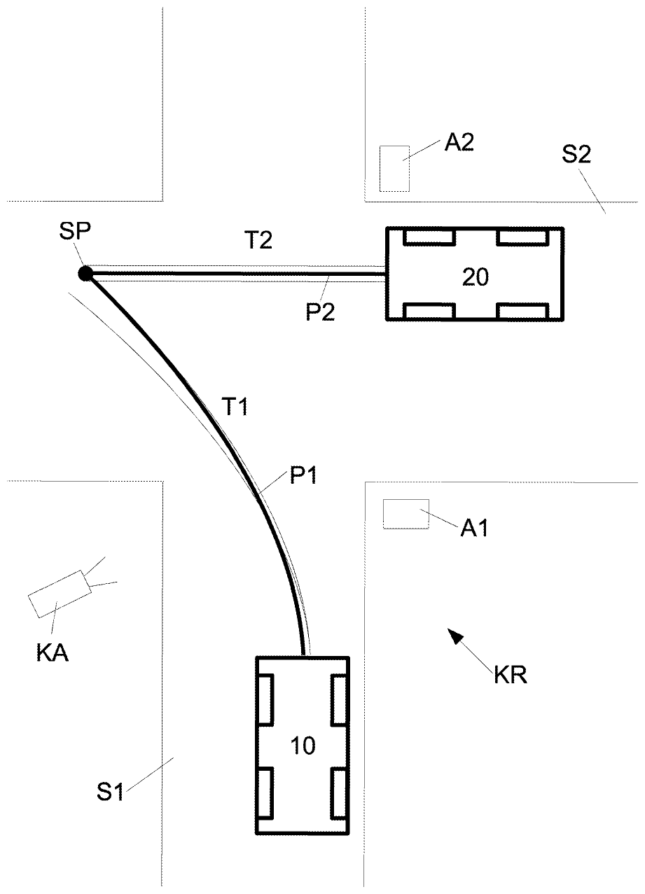

### CROSS-REFERENCE TO RELATED APPLICATIONS

The present application claims the benefit and/or priority of German Application No. 10 2022 212 414.6 filed on Nov. 21, 2022, the content of which is incorporated by reference herein.

### BACKGROUND

### 1. Field

Embodiments of the present application relate to a method for automatically providing traffic information at an intersection, and to an associated apparatus.

### 2. Related Art

Intersections are typically characterized by two or more roads crossing or by one road joining another. At these junctions, situations often arise in which multiple vehicles want to cross the intersection at the same time, while typically trying to avoid collisions. Up to now, this has typically worked by means of right-of-way rules or light-signaling systems, which are observed by human drivers. Increasingly, however, it is intended for driving to be automated, which means that relevant information must be provided for automated vehicle control. This information can in particular involve traffic information.

### SUMMARY

According to an aspect of an embodiment, there is provided a method for providing traffic information at an intersection, which is carried out in an alternative or better manner than in known designs. According to an aspect of an embodiment, there is provided an associated apparatus.

According to an aspect of an embodiment, there is provided a method for the automated provision of traffic information at an intersection, including: detecting first trajectories of a plurality of vehicles over one or more first time intervals, identifying first paths on the basis of a plurality of first trajectories in each case, and providing the first paths and/or first information derived from them as first traffic information.

By means of such a method, traffic information can be provided, which can be used for monitoring an intersection or for controlling the traffic flow and/or individual vehicles. Detecting trajectories allows actual movements of vehicles to be detected as they cross the intersection. Thus, the first traffic information derived from this gives an indication of how vehicles move near and on the intersection. For example, derived information may be the critical points or intersection points mentioned below, but it may also be other information.

The provision of traffic information is carried out in particular by means of an electronic device. The trajectories are detected in particular by means of environment sensors or other devices. The identification of paths and the derivation of information are also carried out in particular by means of an electronic device.

A trajectory here typically means a path that a vehicle has actually travelled. For example, only a first time interval may be used, which in particular can be contiguous. It is also possible to divide the detection process over multiple first time intervals, which are in particular non-contiguous and/or non-overlapping. Data obtained in this way can then be evaluated and further processed together.

When paths are identified on the basis of the trajectories, the paths can be identified such that they indicate which trajectories are typically driven. For example, techniques such as averaging can be used. The provision of the first traffic information or other information can be carried out in particular in such a way that the information is sent to another unit and/or stored in a memory. This information can then be used, for example, by a vehicle controller or a traffic monitoring system.

In particular, the method can be carried out in a plurality of first time intervals, wherein trajectories that have been detected during a plurality of first time intervals are used together in the identification of first paths for the first time intervals. This allows the detection process to be divided into a plurality of first time intervals, which can share a certain characteristic such as a specific traffic light phase or a specific time of day. This can improve the detection process, since a plurality of such first time intervals, for example each having this characteristic, can be evaluated together.

According to an aspect of an embodiment, the method also includes: detecting second trajectories of a plurality of vehicles over second time intervals, which do not or only partially overlap with the first time intervals, identifying second paths on the basis of a plurality of second trajectories in each case, and providing the second paths and/or second information derived from them as second traffic information.

This allows additional second traffic information to be provided, which can be collected in the second time intervals or one second time interval. In particular, the second time intervals may use a different characteristic than the first time intervals, for example, a different traffic light phase or a different time of day. Essentially, the same comments apply to the second time intervals and the information derived from them as those already given above with regard to the first time intervals.

During the identification of second paths for the second time intervals, trajectories that were detected during a plurality of second time intervals can in particular be used together. In particular, a plurality of second time intervals may have the same characteristic, such as the same traffic light phase, for example. As already explained above with regard to the first time intervals, this means the detection process can be carried out over multiple such second time intervals, thereby improving it.

According to an aspect of an embodiment, the first time intervals correspond to a first traffic light phase and the second time intervals to a second traffic light phase. This allows the time intervals to cover different traffic light phases. Specific traffic information can thus be provided for each traffic light phase.

According to an aspect of an embodiment, the first and second time intervals are assigned to a time of day and/or to a time span extending over more than one day. In particular, the first and second time intervals are assigned to the same time of day and/or the same time span extending over more than one day. For example, a time of day can be specified as a specific time or as a time interval with a start time and an end time. For example, a time span extending over more than one day can include a plurality of time intervals on one day. Such times of day or time spans can also be specified specifically for weekdays or for specific days, such as holidays. They typically recur every day or on specified days. Thus, for example, the first and second time intervals can be assigned to specific time spans in commuter traffic. For example, as a further subdivision, the time intervals can be assigned to different traffic light phases, for example, wherein the first time interval can be assigned to a first traffic light phase and the second time interval to a second traffic light phase.

The first time intervals can be assigned in particular to a first time of day and/or to a first time span extending over more than one day, wherein in particular the second time intervals can be assigned to a second time of day and/or to a second time span extending over more than one day. This case can be used, for example, if the first time intervals are intended to cover the morning and the second time intervals to cover the afternoon. Start and end times can be set accordingly.

In principle, more than the first and second time interval, or the first and second time intervals, can be used. Accordingly, third, fourth, fifth etc. time intervals can be used. The comments made for the first and second time intervals apply accordingly.

In particular, intersection points of paths can be identified on the basis of the paths as derived information. Such intersection points are typically points at an intersection where vehicles following different typical paths can meet. Accordingly, there is an increased risk of collision at such points. Providing such information can reduce the risk of collision.

The intersection points can be provided in particular as traffic information or as part of the traffic information. They can therefore be used, for example, in the context of an intersection crossing control, traffic monitoring system or control system of individual vehicles.

According to an aspect of an embodiment, only the paths are provided as traffic information. This allows for simple post-processing of these paths.

According to an aspect of an embodiment, additional or alternative information is provided as traffic information.

The traffic information may be provided in particular to one or more motor vehicles or vehicles and/or to a database. By providing the information to vehicles, it can be used as part of a vehicle control system, thereby improving traffic flow and/or increasing traffic safety. If the information is provided to a database, the information can be provided, for example, for retrieval by road users or for retrieval by evaluation functions such as in the context of traffic planning. Further statistical analyses and optimization of traffic flow or urban planning are also possible.

Preferably, the trajectories can be detected by means of one or more environment sensors. This allows simple detection of the respective position and thus also the trajectories of vehicles.

In particular, some or all of the environment sensors may be selected from the following group: camera, radar, lidar, contact loop.

Any combination or grouping of such environment sensors is possible.

In particular, the trajectories can be detected by means of vehicle-to-X communication. Information which vehicles transmit anyway as part of vehicle-to-X communication can be accessed, for example as cooperative awareness messages, which typically contain current data of the vehicle such as location, speed and course. This allows simple detection of the trajectories on the basis of such information.

According to an aspect of an embodiment, there is provided an apparatus for providing traffic information, which is configured to carry out a method as described herein. With regard to the method, reference can be made to all of the embodiments and variants described herein. In particular, the device may comprise storage means and processor means, the storage means storing program code, during the execution of which the processor means carry out a method as described herein.

According to an aspect of an embodiment, there is provided a non-volatile, computer-readable storage medium on which program code is stored, during the execution of which a processor executes a method as described here. With regard to the method, reference can be made to all of the embodiments and variants described herein.

The aforementioned environment sensors can be arranged in particular on infrastructure such as traffic lights, street lamps, buildings or other objects. In particular, they are not mounted in vehicles, but are mounted on the road.

The information obtained can be made available to vehicles via vehicle-to-X communication, for example.

In particular, the path of objects at the intersection can be tracked using sensors of an intelligent intersection. Raw data or fused objects from sensors such as cameras, radar and/or lasers, can be used for this purpose. This allows so-called ant trails to be generated. These can also be referred to as paths.

Individual tracks can be derived from these individual raw/fusion data points, which when collated provide a very good picture of the movements at the intersection, which can also be grouped by the traffic light phases and the temporal conditions. Combining these ant trails into ant trail bundles based on certain criteria, such as time of day, opens up new possibilities for data generation at an intelligent intersection. An evaluation by an artificial intelligence system can also be used at this point. For example, an interconnection map is created, which can be transmitted to the vehicles.

The interconnection map generated by the ant trails can identify the critical points at the intersection in relation to the traffic light phases, where an accident is more likely to occur, and transmit all of them or only the relevant ones depending on the traffic light phase.

Transmitting the generated data to vehicles, map manufacturers and apps opens up new avenues for future enhanced features.

In particular, the evaluation can also be used for downstream data generation.

In particular, connection data at an intersection can be identified automatically and can be updated daily if changes occur. Connection data can be related to a time interval, for example, in relation to traffic light phases. Critical points in an intersection (for example with increased risk of accidents) can be identified automatically, particularly in relation to the traffic light phases. Data can be shared with map manufacturers, vehicles, mobile phone apps, tablet apps, and other users. The map manufacturers then do not have to perform the labor-intensive processing of the maps manually.

### BRIEF DESCRIPTION OF THE DRAWINGS

Further features and advantages will be gathered by a person skilled in the art from the exemplary embodiment described below with reference to the appended drawing, in which:

The FIGURE illustrates an intersection according to an embodiment.

### DETAILED DESCRIPTION

The FIGURE shows an intersection KR, where a first road S1 and a second road S2 cross. Purely by way of example, the FIGURE shows a first vehicle 10 and a second vehicle 20, where the first vehicle 10 is driving on the first road S1 towards the intersection KR and the second vehicle 20 is driving on the second road S2 towards the intersection KR. As shown, the intersection KR is controlled by a first traffic light A1 and a second traffic light A2. The first traffic light A1 blocks or allows access from the first road S1, and the second traffic light A2 blocks or allows access from the second road S2.

Next to the intersection KR, an environment sensor in the form of a camera KA is positioned, which monitors traffic situations and detects trajectories of the vehicles.

To turn left from the first road S1, for example, different first trajectories T1 can be followed. These are shown here purely as examples and in schematic form. Similarly, to cross the intersection KR in a straight line from the second road S2, different second trajectories T2 can be followed. These are detected for different vehicles that have crossed the intersection KR.

From the first trajectories T1, a first path P1 is computed, which can be understood as a kind of average of the first trajectories T1. Similarly, from the second trajectories T2 a second path P2 is computed, which can be understood as a kind of average of the second trajectories T2. The first trajectories T1 are detected during first time intervals, which correspond to a green phase of the first traffic light A1 and hence to a red phase of the second traffic light A2. The second trajectories T2 are detected during second time intervals which correspond to a green phase of the second traffic light A2 and hence to a red phase of the first traffic light A1.

The calculated paths can be used to evaluate the traffic situation and also to send up-to-date information about the traffic situation to the vehicles 10, 20, for example using vehicle-to-X communication. In addition, the accident situation or the accident risk at the intersection KR can be analyzed, for which purpose, for example, an intersection point SP can be identified at which the paths P1, P2 cross. At such points, an increased risk of accidents typically occurs, because, for example, a vehicle that crosses the intersection KR in violation of the traffic light phases would be particularly likely to collide with another vehicle at such an intersection point. This therefore represents a critical point.

In general, it should be pointed out that vehicle-to-X communication is understood to mean in particular a direct communication between vehicles and/or between vehicles and infrastructure devices. By way of example, it may thus be vehicle-to-vehicle communication or vehicle-to-infrastructure communication. Where this application refers to a communication between vehicles, said communication can fundamentally take place as part of a vehicle-to-vehicle communication, for example, which is typically effected without switching by a mobile radio network or a similar external infrastructure and which must therefore be distinguished from other solutions based on a mobile radio network, for example. By way of example, a vehicle-to-X communication can be effected using the IEEE 802.11p or IEEE 1609.4 standard. Other examples of communication technologies include LTE-V2X, 5G-V2X, C-V2X, WLAN, WiMax, UWB or Bluetooth. A vehicle-to-X communication can also be referred to as C2X communication. The subareas can be referred to as C2C or C2I. However, the embodiment does not exclude vehicle-to-X communication with switching via a mobile radio network, for example.

Mentioned steps of the method according to the disclosure can be executed in the order indicated. However, they can also be executed in a different order, insofar as is technically appropriate. In one of its embodiments, for example with a specific combination of steps, the method according to the disclosure can be executed in such a way that no further steps are executed. However, in principle, further steps can also be executed, including steps that have not been mentioned.

It is pointed out that features may be described in combination in the claims and in the description, for example in order to facilitate understanding, even though these can also be used separately from one another. A person skilled in the art will recognize that such features, independently of one another, can also be combined with other features or combinations of features.

1. A method for delivering traffic information at an intersection, the method comprising:
detecting first trajectories of a plurality of vehicles over one or more first time intervals;
identifying first paths, on the basis of a plurality of first trajectories in each case; and
providing the first paths and/or first information derived from the first paths as first traffic information.

2. The method as claimed in claim 1, wherein identifying the first paths comprises identifying the first paths on the basis of the plurality of first trajectories during a plurality of first time intervals.

3. The as claimed in claim 2, further comprising:
detecting second trajectories of a plurality of vehicles over second time intervals that do not overlap with the plurality of first time intervals;
identifying second paths, on the basis of a plurality of second trajectories in each case; and
providing the second paths and/or second information derived from the second paths as second traffic information.

4. The method as claimed in claim 3, wherein identifying the second paths comprises identifying the second paths on the basis of the plurality of second trajectories detected during a plurality of second time intervals.

5. The method as claimed in claim 4, wherein the plurality of first time intervals correspond to a first traffic light phase and the plurality of second time intervals correspond to a second traffic light phase.

6. The method as claimed in claim 5, wherein the first time intervals and the second time intervals are assigned to a time of day and/or to a time span extending over more than one day.

7. The method as claimed in claim 5, wherein the plurality of first time intervals are assigned to a first time of day and/or to a first time span extending over more than one day, and
wherein the plurality of second time intervals are assigned to a second time of day and/or to a second time span extending over more than one day.

8. The method as claimed in claim 7, wherein intersection points of paths are identified on the basis of the paths as derived information.

9. The method as claimed in claim 8, wherein the intersection points are provided as traffic information or as part of the traffic information.

10. The method as claimed in claim 9, wherein the paths are provided as traffic information.

11. The method as claimed in claim 10, wherein the traffic information is provided to one or more vehicles and/or to a database.

12. The method as claimed in claim 11, wherein the trajectories are detected by means of one or more environment sensors.

13. The method as claimed in claim 12, wherein the one or more environment sensors are cameras, radars, lidars, or contact loops.

14. The method as claimed in claim 13, wherein the trajectories are detected by means of vehicle-to-X communication.
